(19) United States
(12) Patent Application Publication
(10) Pub. No.: US 2014/0081612 A1
(43) Pub. Date: Mar. 20, 2014

(54) Adaptive Physics Engine for Rendering Rigid Body and or Soft Body Physics for Virtual Objects in Contact with Voxelized Fluid

(71) Applicants: Daniel Jonathan Ignatoff, Hayward, CA (US); Semen M. Kozlov, Burlingame, CA (US); Kevin Kaichuan He, San Jose, CA (US); Tyler Randall Mullen, Menlo Park, CA (US); David Baszucki, Portola Valley, CA (US)

(72) Inventors: Daniel Jonathan Ignatoff, Hayward, CA (US); Semen M. Kozlov, Burlingame, CA (US); Kevin Kaichuan He, San Jose, CA (US); Tyler Randall Mullen, Menlo Park, CA (US); David Baszucki, Portola Valley, CA (US)

(21) Appl. No.: 13/621,384

(22) Filed: Sep. 17, 2012

(51) Int. Cl. G06G 7/48

(52) U.S. Cl. 703/9

(57) ABSTRACT

A method for determining forces on a rigid body at least partially immersed in a fluid medium includes steps for (a) dividing the rigid body into a number of cells; (b) calculating buoyancy force on each rigid body cell separately, taking into account properties of the fluid medium, situation as to submersion of each cell, and position of each cell in the rigid body; and (c) integrating the separate buoyancy forces to determine the net force vector and any torque on the rigid body.

### BACKGROUND OF THE INVENTION

1. Field of the Invention

The present invention is in the field of physics simulation of virtual objects and pertains particularly to methods and apparatus for dynamically integrating physics simulation of motion dynamics for soft and or rigid body objects affected by contact with a voxelized medium based upon the nature of the contact and the physics properties of the voxelized medium.

2. Discussion of the State of the Art

Physics simulation is the process of computerized simulation of motion and other physical dynamics of virtual objects like rigid and or soft bodied virtual objects used in video gaming and other computer-aided simulations. Typically, a physics engine (computer software) may be programmed to simulate rigid body, soft body, and fluid dynamics relative to computer graphics and video gaming platforms. A physics engine may run on a central processing unit (CPU) or on a special processor such as a physics processing unit (PPU). The physics engine is responsible for calculating motion dynamics for the virtual objects according to trigger events such as detected collisions and other interactions between the objects.

A limitation in physics rendering of motion dynamics in computer graphics and video gaming relates to the precision of the positional data of the objects and the precision of the values of the forces acting upon the objects. Furthermore, there are computational limitations in reaching high-level visual representation of such motion dynamics. Generally speaking, the better resolution and accuracy regarding the motion dynamics of a represented object, the more computationally complex the process may be, often requiring dedicated and expensive processors capable of higher-level physics simulations. Higher resolution dynamics are more difficult to manage in real time using traditionally available processing resources. Therefore, the physics engine calculates using approximations rather than precise data. In this way the requirements for processing resources are more economical. The trade off is a less realistic view and experience of the motion dynamics of the represented objects from the client's perspective.

Therefore, what is clearly needed is a system for computer simulation of rigid and or soft body virtual objects affected by contact at least with a voxelized medium.

### SUMMARY OF THE INVENTION

The problem stated above is that in the art of video gaming, accurate physics rendering effects are desired for representing the buoyancy and related motion dynamics of rigid objects in contact with a simulated fluid like water. However, many of the conventional means for achieving a more visually realistic physics rendering on simple and more complex game objects in contact with water, like smoothed particle simulation (SPH) or the well-known Eulerian method, also create dependency on more expensive processing resources. The inventors therefore considered functional components of a video gaming system, looking for elements that exhibit the potential for programmed interoperability that could potentially be harnessed to provide more visually realistic simulation of motion dynamics for a rigid and or soft-bodied virtual object in contact with a fluid like water, for example, but in a manner that would not create requirements for more expensive processing resources.

Many video gaming systems are driven by physics simulation of virtual objects during runtime of the game, one by-product of which is a dependence upon processing power that is sufficient to run all of the physics simulations triggered by contact or other trigger in real time. Many video gaming systems employ physics rendering engines to render the appropriate motion dynamics for virtual objects coming in contact with other objects, terrain, or triggered by some other type of event. Voxel grid systems are also utilized by some gaming systems to represent terrain, architecture, and other more permanent features of a game. Physics simulation engines, servers, and three-dimensional (3D) data storage systems like a Voxel grid are typically a part of such apparatus.

In various embodiments of the present invention, a system is provided for rendering physics for virtual rigid body and/or soft body objects in contact with a voxelized medium comprising at least one virtual object having a rigid and or soft body governed by physics simulation engine, a number of voxel cells representing the medium in a voxel grid, a server connected to a network, the server having access to at least one processor and a data repository, the server including a non-transitory physical medium, and software running from the non-transitory physical medium, the software providing a first function for detecting contact, and the nature thereof, between the at least one virtual object and the voxelized medium, a second function for acquiring the physics properties relative to the voxelized fluid and the type of contact at the region of contact, a third function for incorporating the properties as variables into at least one algorithm running on the physics engine to calculate forces and subsequent motion dynamics for the at least one virtual object in contact with the voxelized medium, and a fourth function for rendering the motion dynamics during the period of contact between the at least one virtual object and the voxelized medium.

In one embodiment the system is used in video gaming and the network is the Internet network. Also in an embodiment the voxelized medium is water and the nature of contact is immersion of the virtual object into the body of water. Also in an embodiment the voxelized medium represents a water cascade and the nature of contact is tumbling of the virtual object down the cascade. In another embodiment the voxelized medium is air.

In one case the voxelized medium represents a stream having a current and the nature of contact is immersion of the virtual object into the current flow and movement of the object through the current. In another case the voxelized medium has one or more of the properties of salinity, viscosity, depth, flow direction, flow velocity, wave action, tidal pull, and opacity. Also in some cases the first function further detects contact in the form of collision between two or more virtual objects, one or both objects also having contact with the voxelized fluid. The third function may further incorporate the physical dynamics of the collision or collisions between the two or more virtual objects to calculate subsequent motion dynamics for the virtual objects. The virtual object may be a rigid body or an articulated multi-rigid body.

In another aspect of the invention, in a system for rendering physics for rigid and/or soft bodied virtual objects, a method for dynamic calculation of rigid and or soft body motion dynamics in contact with a voxelized medium is provided, comprising the steps of (a) detecting initial contact between a virtual object and the voxelized medium; (b) acquiring voxel data relevant to the voxelized medium properties; (c) incorporating one or more voxel data values relative to the voxelized medium into one or more algorithms for rendering motion physics for the virtual object having contact with the voxelized fluid; (d) calculating the dynamic motion physics for the virtual object in light of the nature of the contact and voxel data used as input; and (e) rendering the dynamic motion physics for the virtual object for the duration of the contact between the object and the voxelized medium.

In one embodiment of the method, in step (a), the voxelized medium is water and the nature of contact is immersion of the virtual object into a volume of the water. Also in one embodiment in step (a) the voxelized medium is a water cascade and the nature of contact creates tumbling of the virtual object down the cascade. Still in one embodiment the voxelized medium is a stream having a current and the nature of contact is immersion of the virtual object into the current flow, and a result is rendering motion of the object through the current.

In various embodiments the voxelized medium has one or more of the properties salinity, viscosity, depth, flow direction, flow velocity, wave action, tidal pull, and opacity. There may be a further step for monitoring for and detecting further contact in the form of collision between two or more virtual objects having contact with the voxelized medium. There may also be a step for incorporating the physical dynamics of the collision between the two or more virtual objects to calculate alternate buoyancies and subsequent motion dynamics for the virtual objects resulting from the collision angle or angles and force of the collision or collisions.

In many cases the virtual object may be a hybrid object incorporating both rigid body properties and soft body properties. Also in many cases the the rigid body and/or soft body may be an avatar. The method may be practiced on a video gaming platform, wherein the functions of steps (c), (d), and (e) are supported dynamically by any one or multiples of a number of processors of user gaming devices connected to and playing the video game running on the platform.

### BRIEF DESCRIPTION OF THE DRAWING FIGURES

FIG. 1 is an architectural overview of a gaming network according to an embodiment of the invention.

FIG. 2 is an interaction sequence chart depicting a sequence of interaction between components of the present invention.

FIG. 3 is a block diagram depicting part of a voxel grid containing voxelized water according to an embodiment of the present invention.

FIG. 4 is a block diagram depicting a voxel cube divided into multiple sections to distribute physics properties of buoyancy.

FIG. 5 is a block diagram depicting final orientation of a block immersed in standing fluid according to density values.

FIG. 6 is a block diagram depicting final orientations of a sphere and a cylinder in contact with standing fluid according to an embodiment of the present invention.

FIG. 7 is a block diagram depicting a cube placed in contact with moving fluid and subjected to a contact force to generate simulated motion for the cube according to various forces.

FIG. 8 is a process flow chart depicting steps for simulating integrated motion dynamics for an object during contact with voxelized fluid that is influenced by subsequent contact with another object.

FIG. 9 is a diagram depicting a rigid body in a fluid medium illustrating another embodiment of the invention.

### DETAILED DESCRIPTION

The present invention is described in this specification in enabling detail using the following examples, which may describe more than one relevant embodiment falling within the scope of the present invention. The inventors provide a system and methods for rendering physics including motion dynamics for rigid and soft-bodied virtual objects that have come in contact with voxelized medium, such as a simulated fluid. The term “voxel” in the art refers to volumetric pixel, or volumetric picture element. Water in many applications is a good example of such a voxelized medium. The present invention is described in enabling detail using the several examples, which may describe more than one relevant embodiment falling within the scope of the present invention.

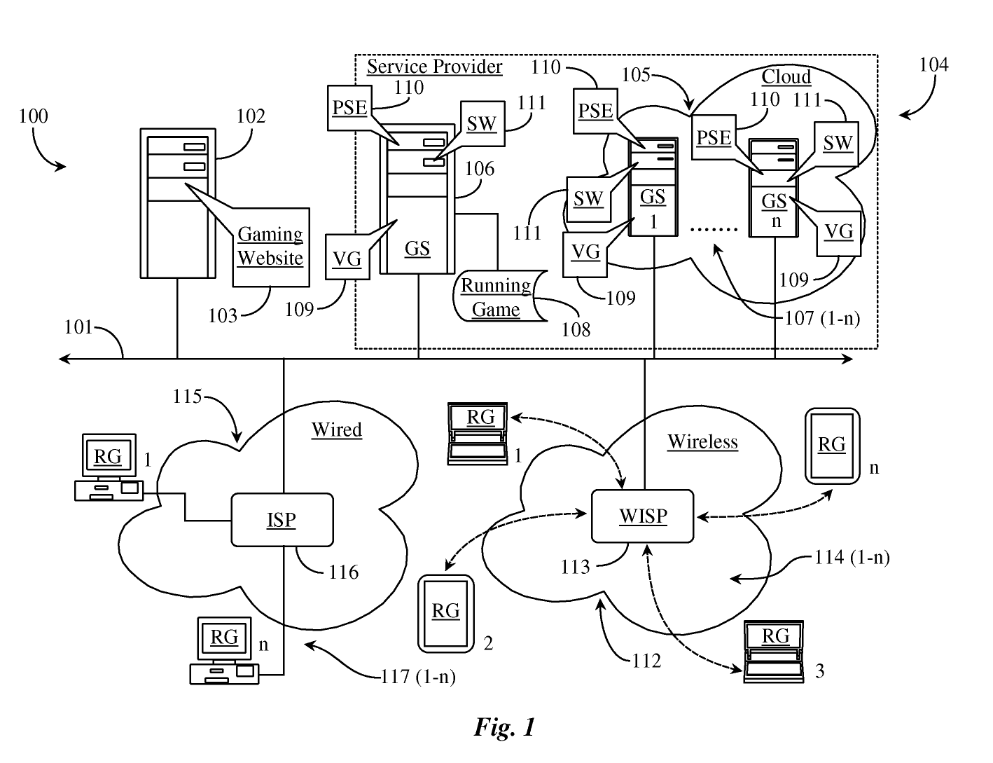

FIG. 1 is an architectural overview of a gaming network 100 according to an embodiment of the invention. Network 100 includes the Internet network represented herein by a network backbone 101. Network backbone 101 represent all of the lines, equipment, and access points that make up the Internet as a whole including connected sub-networks. Therefore, there are no geographic limitations to the practice of the present invention.

Internet 101 supports a web server 102 adapted to serve electronic information pages known as web pages in the art. Server 102 includes a non-transitory physical medium that contains all of the data and software required to enable function as an Internet web server. Although not illustrated here, web server 102 includes at least one processor for performing computing and processing functions and at least one data repository adapted to store client and website information along with gaming statistics for clients. Server 102 may be operated by a third-party web hosting service or by a gaming services provider without departing from the spirit and scope of the present invention. Server 102 hosts a gaming website 103. Gaming website 103 serves as an access point for clients of a gaming service provider. The website may include pages for client registration, social interaction, game building, and game playing.

A service provider domain 104 is depicted in this example. Service provider 104 represents any company that offers virtual gaming over the Internet network. Service provider 104 includes at least one game server (GS) 106. Game server 106 includes a non-transitory physical medium that contains all of the data and software required to enable function as a game server. When a client of website 103 clicks on a game to play, the client is redirected to server 106 or a like game server. In this example, game server 106 is hosting a running game 108. A physics engine (PSE) 110 is provided to execute on gaming server 106 to render real-time physics relative to game objects during game play such as dynamic motion, for example. PSE 110 may include rigid-body and soft-body physics simulation.

Game server 106 has access to a voxel grid (VG) 109 for storing data relative to voxelized objects and terrain used in the game environment of running games like game 108. In one embodiment, a significant amount of game objects, buildings, terrain, etc. are represented in voxel grid 109. Game server 106 is a logical representation in this example that is intended to include object storage and service, data storage service, file storage and service, and any other adjunct services required for game operation and play. Such apparatus may include one or more networked machines and data repositories. In one embodiment of the invention, service provider 104 leases or maintains a computing cloud illustrated herein as cloud 105. Cloud 105 may incorporate game servers 107 (1-n). Game servers 107 (1-n) are analogous in description to game server 106. Each game server 107 (1-n) has access to instances of PSE 110 and VG 109.

Clients of gaming website 103 serviced by provider 104 operate from a variety of gaming appliances and may access services over various carrier networks. A wired carrier network 115 is illustrated in this example, and represents any wired connection to services such as a local area network (LAN) or wide area network (WAN). Wired access by clients is represented by gaming appliances 117 (1-n) connected to an Internet service provider (ISP) 116 having connection to backbone 101. A wireless carrier network 112 is illustrated in this example, and represents any wireless connection to services such as wireless fidelity (WiFi), wireless LAN (WLAN), or municipal area network (MAN).

Wireless access by clients is represented herein by gaming appliances 114 (1-n) connected to wireless ISP (WISP) 113 having connection to Internet backbone 101. Gaming appliances may include desktop computing machines, dedicated gaming devices, smart phones including android devices, laptops, notebooks, and I-Pad like devices. In the present example, all of the gaming appliances have displays with the label RG signifying that all of the devices are actively engaged and playing running game 108.

In one embodiment of the present invention, a software adaptor or middleware 111 is provided and is adapted to integrate physics properties assigned to a voxelized medium stored in VG 109 with physics simulation operations available in PSE 110 for simulating physics of rigid and or soft-bodied objects associated with game 108. In this embodiment, the medium is fluid, and is stored in VG 109 much like terrain except that the stored fluid is assigned special fluidic properties in accordance with normal Newtonian laws governing physics. The fluid may be water in one embodiment. In another embodiment, the fluid may be lava, wet mud, quicksand, or any other liquid that might have definable properties. In the embodiment where the fluid is water, the special properties may include water density, water opacity, water flow force, water flow direction, water salinity (increases buoyancy for buoyant objects), water viscosity (drag), tidal states, pressure fluctuations, and other properties.

All of the special physical properties assigned to the voxelized fluid are stored in VG 109 within the voxel cells containing the fluid. It is noted herein as well that some voxel cells may contain more fluid than other voxel cells and the collection of voxel cells containing fluid may represent, in the water embodiment, a standing body of water having various depths, a flowing steam, a water vortex, a waterfall, a small pool of water, and so on. The properties, both general and local, are included in each water voxel cell. The same types of physics properties are applied to other types of fluid stored in a voxel cell and are also included within each voxel cell of the fluid. The ISO boundary of the group of voxel cells containing liquid is the border against voxel cells containing terrain or other materials like sand, concrete, grass, sky, etc.

In practice of the present invention, according to one embodiment, SW 111 is called according to a trigger event. One such trigger event is the fact of a rigid or soft-bodied object in a running game making contact with the voxelized fluid at a point in time; such contact may be detected using object collision detection SW (not illustrated). In one embodiment, SW 111 is enhanced for contact or collision detection relative to voxelized fluid in a dedicated manner. In another embodiment, the typical collision detection application known to and available to the inventor is employed, but modified to include the aspects of fluidic contact including monitoring duration of time for the contact event.

A contact event may consist of initial contact, and also of sustained contact, such as an object being dropped into a lake and floating after first sinking beneath the surface. The time window for that contact “session” may be the duration of time the object is moving according to the physics of buoyancy and specific gravity among other possible forces. More detail relative to the different types of contact between a rigid or soft-bodied object and voxelized fluid is provided later in this specification.

SW 111 functions in one embodiment to retrieve for, or caused to be served to the PSE, the specific properties and associated values assigned to the voxelized fluid at the moment of contact between the object and the fluid. In one embodiment, such a contact event may be predicted by taking into account dynamic motion of the object such as velocity (which includes direction), and by taking into account the rate of closure relative to the closing distance between the object and the voxelized fluid. It is noted herein that the specific properties might vary between different voxel cells containing fluid. The PSE has the specific properties related to the object in question and renders normal physics for the object accordingly. PSE receives the values and properties of the expected contact at or just before contact occurs, and those values are used in an integrated computation to alter the motion dynamics of the object making contact with the fluid to produce, at minimum, buoyancy physics for the object in a realistic manner.

SW 111 is shown separately from PSE 110 in this example for illustrative purpose only. SW 111 may be bundled in with PSE 110 without departing from the spirit and scope of the present invention. SW 111 may function as a middleware adapter provided inline between the voxel grid representation and PSE 110. There may be multiple objects of rigid and/or soft body type active in any game simultaneously. These objects are managed differently according to the effects of the fluidic physics in light of the physics of the object making contact with the fluid. Moreover, a subsequent contact between the object making contact with the fluid and another object in contact with the fluid results in the normal PSE simulation of object-to-object contact that is further augmented according to the fluidic physics still affecting the simulation of at least one of the objects provided the other object was stationary, as for example an underwater stone or hazard.

In one embodiment the objects making contact with voxelized fluid may also bevoxelized objects. The fluidic properties used to influence the motion dynamics of the object are disbursed about the object such as within the peripheral voxels of the object. In this way the motion dynamics include simulation of forces affecting any portion or portions of a larger object producing realistic rotations, swirls, bobs, and sways that would, for example, characterize a cube floating in a moving stream and being affected by the current. Subsequent object-to-object contact may be detected while one or both of the objects are still in contact with the fluid.

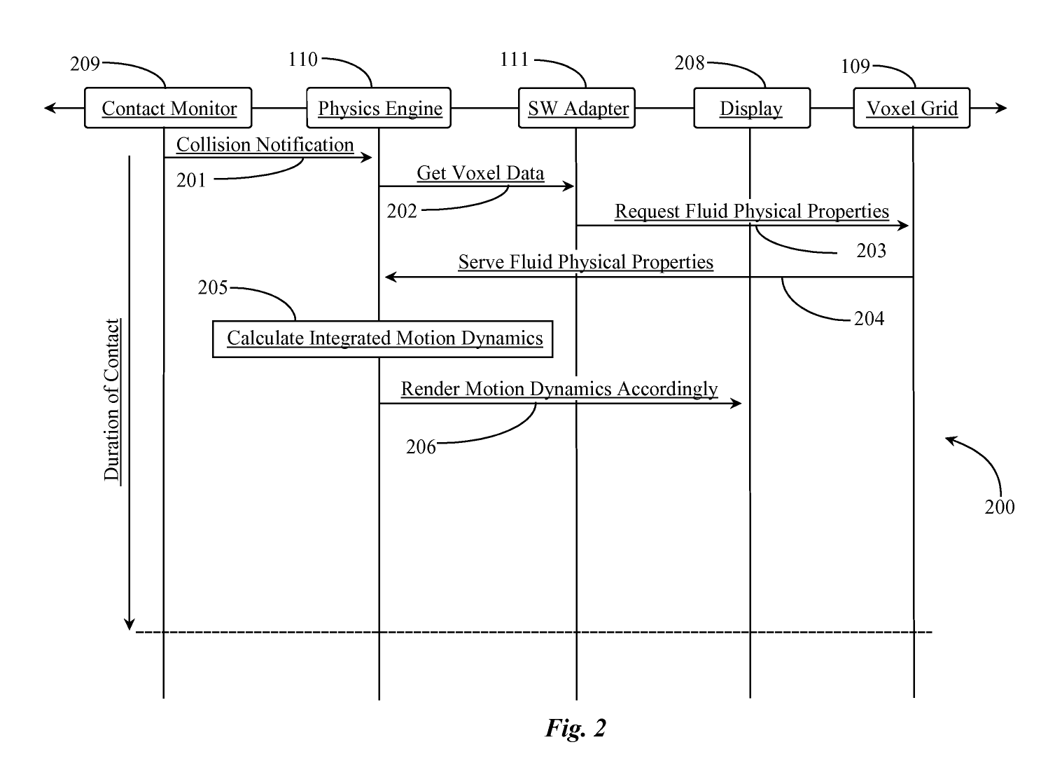

FIG. 2 is an interaction sequence chart 200 depicting a sequence of interactions between components in an embodiment of the present invention. Chart 200 incorporates components such as physics engine 110, SW adapter 110, Voxel Grid 109, a display 208 and a contact monitor 209. Contact monitor 209 detects contact between a rigid or soft body object with fluid stored in voxel grid 209. The rigid or soft body object may be a voxel object and may also be stored in a voxel grid analogous to grid 109. The parameters for detecting collision between an object and water are included in the contact pipeline documenting the nature of the contact. For example, there may be more than one class of water represented on a voxel grid. A standing lake may sit adjacent to a meandering stream or river. The water voxels are bounded, most likely by terrain.

Contact between an object and the standing lake will be quite different than contact between the same object and the meandering stream. In this regard, collision events have their own properties and values based on type of collision and fluidic properties associated with the voxelized water with which the object makes contact. The contact monitor begins a sequence of interaction at 201 by notifying physics engine 110 of a collision that has occurred or that is predicted to occur. Once contact monitor issues a notification of contact between object and water, the physics 110 receives the information and issues a command to SW adapter 111 to get voxel data at 202. In one embodiment, SW adapter 111 is incorporated wholly within the PSE SW as a front-end extension. In one embodiment SW 111 is incorporated in part to PSE 110 and in part to VG 109. SW 111 requests fluid physical properties along with positional data at 203.

The correct voxel data stored within the voxels involved in the contact event are served to the physics engine at 204. The physics engine utilizes certain values as input variables in algorithmic processing to calculate the correct motion dynamics to render for a rigid body or soft body object in contact with fluid such as water, for example. Simulation of motion dynamics for an object in contact with voxelized water depends upon attributes related to how the contact is made in light of the object properties, and on the attributes of the fluid body. SW adapter 111 enables physics simulation of buoyancy and related motion dynamics.

Referring now back to sequence chart 200, physics engine 110 calculates new motion dynamics in light of voxel fluid properties and values collected at the area of contact. These new motion dynamics represent a modification of motion dynamics for the object but only during a time window within which the state of contact between the object and voxel fluid remains constant. For example, a tree trunk may roll down an embankment and fall into a fast moving creek, the creek simulated using voxel data. The creek's properties include water depth, water density, water flow force and direction, and so on. The tree trunk, similar to a horizontal cylinder, will pitch, sway and rotate as it is carried down the creek current. At the end, the tree trunk could become lodged at a dam, logjam or at some location on the creek not supporting further movement of the trunk.

While the trunk is still in a state of contact with the moving fluid, the physics call for a now stationary object. However, if someone or something breaks the logjam, normal buoyancy physics rendering may resume for the trunk. Some objects will sink, some objects will float on the surface, and some objects may suspend beneath the surface. Physics engine 110, via a rendering component, renders the motion dynamics for the objects accordingly at 206. Voxelized fluid is treated as a special physics object having its own motion dynamics. Taking the example of water, water may flow over and around objects. Water may have a tidal action, wave action, vortex or swirling action, flow force and direction, density properties, and combinations of these physics simulations. Objects and water are simulated according to these intersecting dynamics; for example, an object may displace water and cause a splash and waves if it is dropped into the water body.

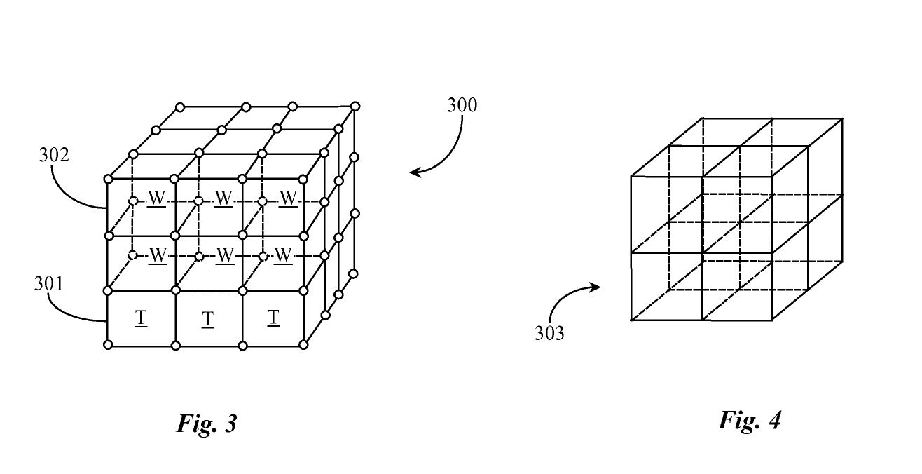

FIG. 3 is a block diagram depicting part of a voxel grid 300 containing voxelized water according to an embodiment of the present invention. In this example a number of voxels contain terrain (T). The terrain may be grass, rock, concrete, or other types of fills. Voxels containing water (W) are present in the grid and have a boundary with the voxels containing terrain. The properties and physics attributes of the water are stored in each of the voxels along with the quantity of water in the voxel. A water voxel may contain any amount of water to a full amount of water allowed in the full volume of the voxel. ISO-Surface extraction or other methods known to the inventor may be practiced to define the body parameters of the water. The water may have properties such as color, density, and opacity as well.

The water voxels may also contain force properties like water flow force and direction. These physics properties are contained in each water voxel and may change over one or more adjacent voxels. For example, in a stream bend, water flows faster at the outside of the bend than at the inside of the bend. Voxels representing water on the outside boundary will have a much higher flow force than the voxels at the inside boundary of the bend Likewise, depth of water voxels would likely be greater at the outside of the bend than inside the bend in the stream. Physics simulation may be used to simulate erosion or undercutting of the voxel terrain by the voxel water at the outside of the bend and terrain deposit at the inside of the bend.

There are many different models for voxelized fluid that include water among other more viscous fluids like oil, lava, quicksand, tar, mud flow, etc. The properties expressed in each representative voxel are used in integrated motion dynamics calculation by the physics engine to calculate the proper motion dynamics for an object making contact with the fluid at the location(s) of those voxels.

FIG. 4 is a block diagram depicting a voxel cube 303 divided into multiple sections (eight in this example) to represent, in distribution, the divided force of buoyancy at each of those sections of the cube. Cube 303 is representative of a voxelized object. Cube 303 may also be a wedge, cylinder, or other geometric volumetric three-dimensional space without departing from the spirit and scope of the present invention. By equally distributing the divided force of buoyancy, voxel objects (cubes, wedges and corner wedges) orient themselves properly and respond to changes in external forces such as a character standing on one corner of the cube causing pitches and yaws with realism. Water viscosity force (drag) may be applied against both linear and rotational velocity of cube 303 to dampen the dynamic motion and achieve a realistic floating effect. Water forces may interact with machine motion dynamics, for example, a water wheel or paddle wheel, or a propeller. Like water voxels, voxels of voxelized objects may contain varied properties. Some areas of an object may have more buoyancy than other areas of the same object. Therefore, the properties of the object, for example, density, material, and weight might be unevenly distributed causing re-orientation when in contact with a fluid like water for example.

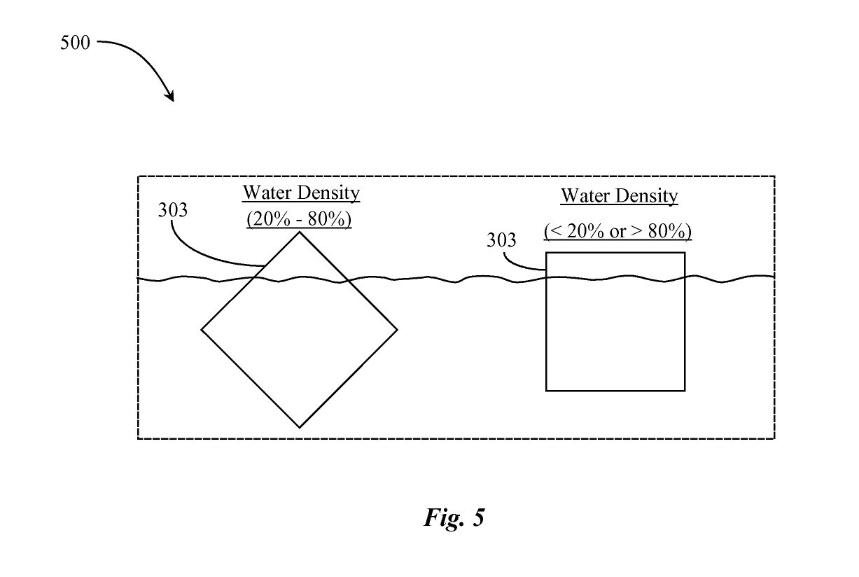

FIG. 5 is a block diagram 500 depicting final buoyancy reorientation of cube 303 of FIG. 4 immersed in fluid according to density values. In this example, voxel cube 303 is in a state of stable orientation after being dropped in deep, standing water and reorienting. This orientation is expected for a block having a density of from 20% to 80% of the density of the fluid. On the right in FIG. 5 the same cube is shown in another state of reorientation if the density of the material of the cube is less than 20% or is greater than 80% of the fluid density. Wedges may exhibit similarly different but consistent reorientations after being dropped into deep standing water, depending on the ratio of object material density to the fluid density.

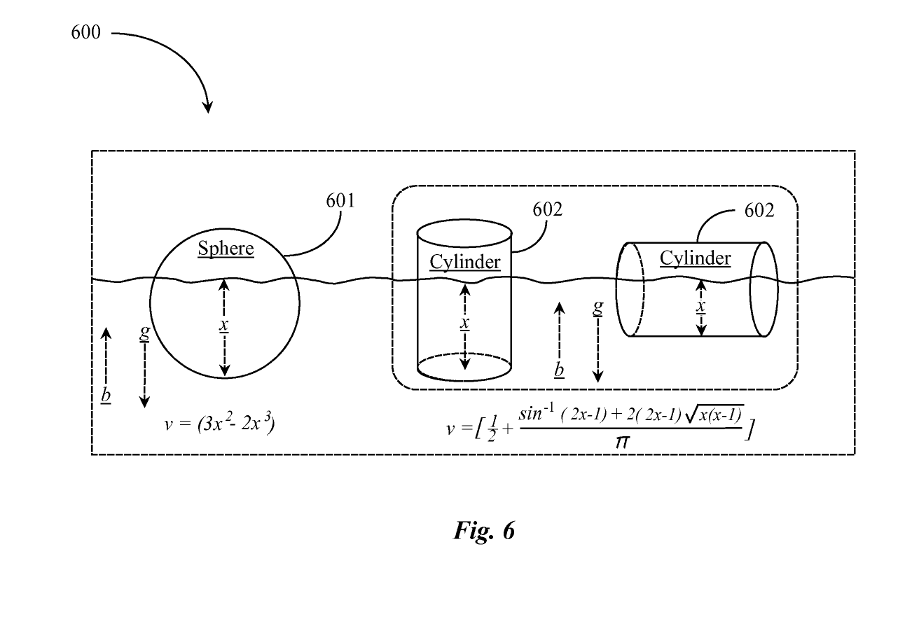

FIG. 6 illustrates final orientations of a sphere and a cylinder immersed in standing fluid according to an embodiment of the present invention. In this example, a sphere 601 is dropped into deep standing water. For a sphere, the smallest point hits the water first. Upon contact, the sphere gradually decelerates as the force of buoyancy (b) takes over and eventually shoots it back up against the force of gravity (g). There is no concern over how a sphere reorients itself due to its uniform shape; however, an important variable for simulation is how much volume (v) of the sphere remains submerged at stable orientation. To determine the submerged volume (v), we want to know the vertical distance along the radius of the sphere that remains underwater. If x is the distance of the sphere's radius that is underwater, then v=3x²−2x³. Buoyancy is the weight of an object times the percentage of volume of the object that is submerged divided by specific gravity.

A sphere may have properties that may affect its buoyancy in water such as the type of material and the weight of the sphere. For example, if the sphere made of iron, it would sink unless the sphere is hollow and there is enough volume within the sphere to provide sufficient buoyancy to float the sphere. Steel ships, for example, float. If the sphere were made of Styrofoam, there might not be much volume submerged beneath the water and the sphere could roll across the water surface by application of an external force like wind, for example.

A cylinder 602 is shown within a broken boundary to the right of sphere 601 to illustrate two reorientation possibilities. For example, if cylinder 602 were dropped into deep standing water vertically, it would be expected to achieve reorientation much like a cube. Conversely, if cylinder 602 is dropped into the water perfectly horizontally, it is expected to achieve reorientation much like a sphere. To realistically simulate a cylinder, two approaches, one for cube and one for sphere may be blended.

Taking the horizontal cylinder, if x is the percentage of the horizontal cylinder that is underwater, then the percentage of the cylinder's volume that is submerged is:

$$v = [ \frac{\frac{1}{2} + {sin}^{- 1} ( 2 x - 1 ) + 2 ( 2 x - 1 ) \sqrt{x ( x - 1 )}}{π} ]$$

Again, the buoyancy is weight of object×percentage of volume submerged÷SPECIFIC GRAVITY.

This blend of the two approaches allows cylinders to behave realistically in water, and barring any other immediate forces such as current, waves, etc., cylinder 602 will float more like a natural cylinder instead of only a sphere or only a cube.

By considering the force of buoyancy in each object voxel cell, and integrating the individual effects to determine the overall effect on the object, the object collectively behaves much more realistically in a real time simulation of buoyancy. Complex objects like boats, rafts and other water machines may be constructed to float, pitch, and yaw realistically by application of the principles of the present invention. Successes and failures depend upon the soundness of the construction technique of the boat. For example, a boat that is missing a backboard will eventually sink. A raft made of the wrong material type may also sink or otherwise not hold or float at the surface with any weight on it. By simulating the force of drag (water viscosity) objects like paddles, oars, hands, feet, flippers, propellers, etc. may be used to propel avatars, boats, canoes, and other craft including motorized craft through the water. The method of the invention may also work to provide more realistic buoyancy physics for a vessel that uses buoyancy to navigate like a submarine for example. This principal may also be applied to certain sea creatures, fish and other soft-bodied objects.

In one embodiment of the present invention, a distributed physics simulation model (known to the inventor) is used to enable distributed processing of calculation and rendering of motion dynamics and other physics simulations relative to objects coming into contact with a voxelized fluid medium. In such a model, a client with an avatar or boat may process their own physics simulations on the client gaming device by downloading a client application that gives permission for that client to perform certain physics simulation tasks during game play. Typically, this may be limited from geo-perspective by allowing such simulation within a certain radius of the client game piece or avatar. So an avatar may be able to swim, dive, and operate a boat with the resulting physics calculations for motion dynamics and rendering performed from the client device and then communicated (at render) to other clients.

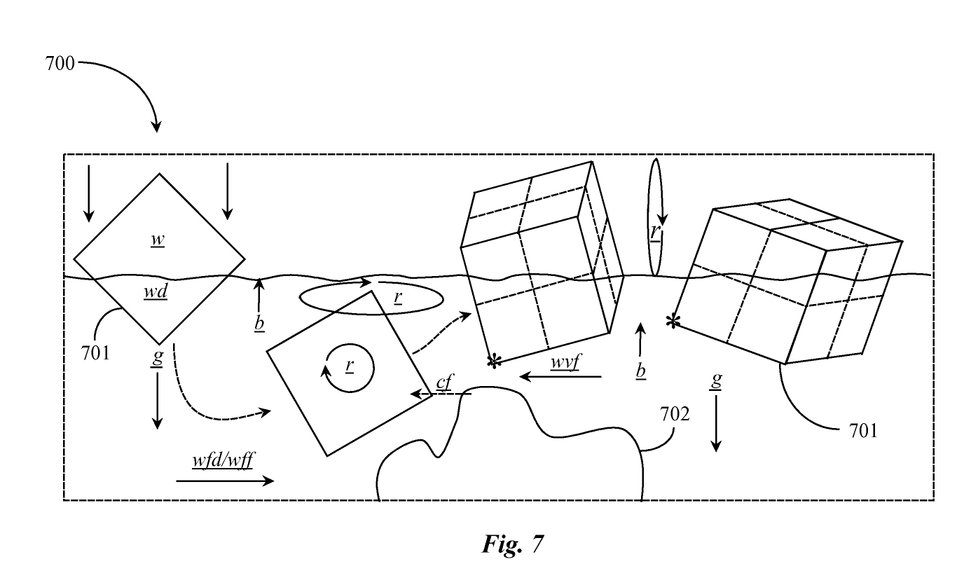

FIG. 7 is a block diagram depicting a cube 701 placed in contact with moving fluid and subjected to a contact force to generate simulated motion for the cube according to various forces. Like the previous example of FIG. 5, cube 701 is dropped into a body of water with a difference in that the water has current moving at a certain direction and force. Gravity (g) brings the cube down into the water at first contact. The water flow direction (wwd) is to the right from a viewer's perspective along the directional arrow. The water has water density (wd) and the cube has weight (w). The water density, weight of the object, speed of descent, specific gravity force and buoyancy force all contribute to the calculation of the motion dynamics as the cube sinks, begins to be affected by the current, and starts to float back to the surface under the force of buoyancy (b).

Cube 701 is seen still under water in the current, and about to come in contact with a stationary object 702, which could be a rock ledge or reef. The object-to object contact is predicted and the contact force (cf) acts against the momentum of the cube floating beneath the surface. The effects of the contact force cause the cube to abruptly rotate (r) over three dimensions of freedom as it is rising back to the surface due to buoyancy. At the same time water viscosity force (wvf) or drag is depicted working against cube 701 as it floats downstream. Gravity works to bring the cube back down into the water, but with not the violence of the first drop, indicative of naturally simulated dissipation of motion dynamics to a level consistent with the forces continually at play while the cube shares contact with the voxelized fluid. Note that the point of contact (*) between obstacle 702 and cube 701 caused the abrupt rotation to occur based on the location of and force of that contact. Thus the instant contact has an altering effect on the buoyancy physics playing out. A cube in contact with water that is subject to fluctuating currents in the water may rotate, swirl, and otherwise be physically affected by the force of the current on different parts of the cube.

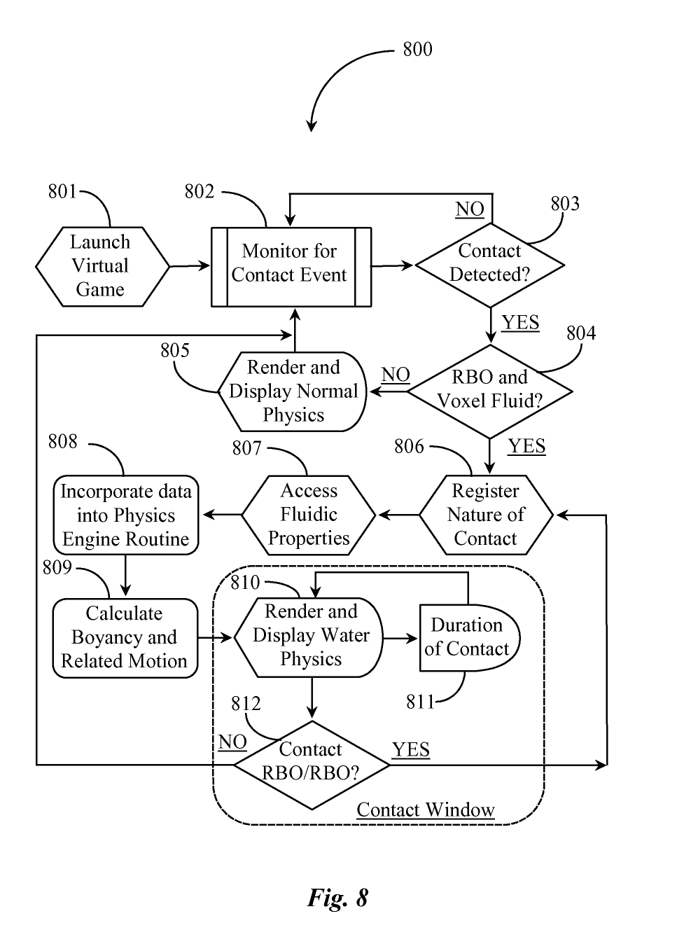

FIG. 8 is a process flow chart 800 depicting steps for simulating motion dynamics for an object during contact with voxelized fluid and by possible further motion dynamics resulting from subsequent contact with another object. At step 801, a game with at least one non-stationary rigid object and at least one special physics object of voxelized fluid is launched. It is assumed in this example, that one or more players are actively playing the virtual game.

At step 802, a contact-monitoring application monitors the active game progression for possible contact between objects, including contact made between the at least one non-stationary object and the voxelized fluid. In one embodiment the voxelized fluid is water. At step 803, if contact is not detected, the process loops back to monitoring. If it is determined that contact has been detected at step 803, the system determines the nature of the contact at step 804. If at step 804, it is determined that the contact is not between a rigid body object and voxel fluid, then the process moves to step 805. At step 805 the system renders and displays normal physics or motion dynamics pursuant to contact between two objects that are not in contact with fluid.

If the system determines that the nature of contact detected was between a rigid body object and voxelized fluid such as water, the process moves to step 806 where the system registers the nature of the contact. The nature of the contact may be that the object is dropped into a standing body of water. The nature of contact may be different such as an object sitting in a dry gulch that fills with water. The nature of contact may be that the object is stationary, but has a moveable machine component such as a paddleboard that makes contact with water such as next to a waterfall. The object may be a boat that is purposely launched down a ramp into water. There are many variant possibilities for framing the nature of contact between stationary and non-stationary objects with voxelized fluid such as water.

It is noted herein that an object can be a stationary object where the water comes into contact with the stationary object like a building, bridge, overhanging tree limb, or some other object for example. The nature of the contact will incorporate some physics properties relative to the object and to the exact “nature” of contact. For example, an object falling from a tall building into a lake will have weight and velocity when it hits the water. These properties are taken into account during determination of the nature of contact. It is noted herein for both stationary and non-stationary objects that contact between those objects and water may be predicted in some cases as described further above in this specification.

At step 807, the properties of the voxelized fluid at the location of contact are acquired for integration into the data fed into the physics engine to simulate physics relative to the contact. At step 808, the voxel fluid properties and contact properties are incorporated into a routine that calculates motion dynamics for the object making contact with the voxelized fluid. Such data may include both constant values attributed to the water and variable values attributed to the water at the area of contact. For example, a river may have a fast moving section and a slow moving section. The voxels representing the river will therefore have differing properties thus assigned according to the forces present such as current.

At step 809, the physics engine calculates the buoyancy and related motion dynamics for the object making contact with the water. If the object is stationary, there may not be any motion dynamics unless the force of the water compromises the object in some way such as washing a house downstream in a flood, or removing items sitting on a porch and having them wash downstream. In a simple embodiment, one can envision the simple buoyancy physics of a floating object like a boat sitting on the water surface. Steps 810 through 812 may be thought of as occurring during a running “contact window” while the contact state between the object and water is active and relatively constant. At step 810, during contact, the system renders and displays the related motion dynamics and water physics for the object making contact with the voxelized fluid. Step 810 may be ongoing for the duration of the contact as shown by step 811. The vibrancy of the motion dynamics may be tempered by water viscosity force (drag) so that the bobbing and swaying does not occur indefinitely sans other present forces. So a buoyant object dropped directly into standing water will bob more at first and will eventually just be floating there in a reoriented state.

During the contact window the object is continually monitored for subsequent contact between it and another rigid body object that may be associated with the voxelized fluid, such as a stationary reef, rock bank, or another non-stationary floating object. At step 812, the system determines if there is contact between objects in contact with water. If there is no further contact detected at step 812, the process continues monitoring at step 802 for the object in contact with water and for other game objects.

However, if there has been contact detected between two or more rigid body objects with one or more of those also in contact with water, the process loops back to step 806 for acquisition of the nature of contact. Contact between two floating objects or between a floating object and a stationary object can have different results on the physics simulations for those objects.

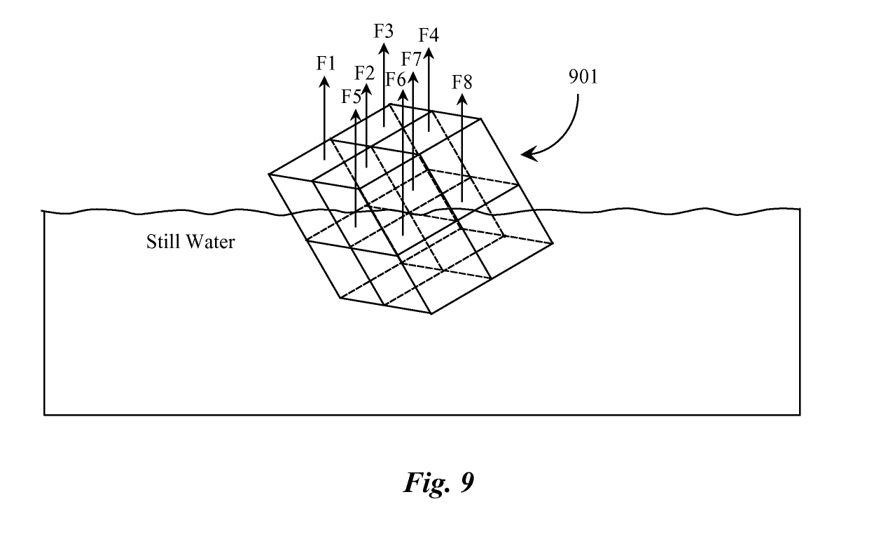

It is a particular object of the invention to provide a process for calculating buoyancy on a rigid object in a manner that allows the forces on the object to be treated in a way that most closely approaches real-world effects. FIG. 9 is a depiction of a rigid body 901 that has been dropped in still water, and has not attained stability. Body 901 is divided in this example into eight cells as shown, some of which are submerged, some partially submerged, and some not submerges at all. The method of the invention in this example is to calculate the buoyancy force on each separate cell, resulting in forces F1 to F8 as indicated in the figure. In this calculation F7, for example, will be zero, because there is no buoyancy force on a cell that is not at all submerged. F6 will be calculated as a body completely submerged, and so on.

When all the buoyancy forces on the separate cells are calculated, they are integrated to determine the net force vector on the whole body, including any torque force on the body. This method provides a means of rendering the motion of the body in a display in a far more realistic way. The vector mathematics is not presented here, as such calculations are well-known to the skilled person.

The example with reference to FIG. 9 is intentionally simple to provide a clear description of the method. It will be apparent to the skilled person that object 901 may be divided into more than the eight cells shown, and it should also be apparent that the cells may be treated as voxel cells as well, where the properties of the rigid body may vary from region to region.

It will be apparent to one with skill in the art that the physics simulation system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A method for determining forces on a rigid body at least partially immersed in a fluid medium, comprising steps of:
(a) dividing the rigid body into a number of cells;
(b) calculating buoyancy force on each rigid body cell separately, taking into account properties of the fluid medium, situation as to submersion of each cell, and position of each cell in the rigid body; and
(c) integrating the separate buoyancy forces to determine the net force vector and any torque on the rigid body.

2. The method of claim 1 wherein the resultant force and torque is used by a physics engine to determine incremental movement of the rigid body, and repeated calculations performed at new positions to determine further movement, which results are used to display movement of the rigid body in a virtual environment.

3. The method of claim 1, wherein the fluid medium is water.

4. The method of claim 1, wherein the fluid medium is air or another gaseous medium.

5. The method of claim 1, wherein the fluid medium is in motion and voxelized as well, and wherein additional steps are performed to determine forces exerted on each rigid body cell by the fluid medium, and these forces are included in the integration to determine the net force vector and any torque on the rigid body.

6. The method of claim 5, wherein the voxels of the fluid medium have one or more of the properties of salinity, viscosity, depth, and flow velocity.
